(19) United States
(12) Patent Application Publication
(10) Pub. No.: US 2018/0161893 A1
(43) Pub. Date: Jun. 14, 2018

(54) APPARATUS FOR DETECTING THE BREAKAGE OF A CUTTING ELEMENT

(71) Applicant: HAAS FOOD EQUIPMENT GMBH, WIEN (AT)

(72) Inventors: JOHANNES HAAS, WIEN (AT); JOSEF HAAS, LEOBENDORF (AT); STEFAN JIRASCHEK, KOENIGSBRUNN (AT); RICHARD SCHRAMMEL, ALTENMARKT (AT); GERHARD LIEBERMANN, MANHARTSBRUNN (AT)

(21) Appl. No.: 15/737,329

(22) PCT Filed: Jun. 14, 2016
(86) PCT No.: PCT/EP2016/063566

§ 371 Date: Dec. 18, 2017

(30) Foreign Application Priority Data
Jun. 18, 2015 (EP) 15172789.8

(51) Int. Cl. B23D 59/00; B26D 5/00; B23D 55/08; B23D 57/00; B26D 1/03; B26D 1/547; B26D 1/553

(52) U.S. Cl. CPC B23D 59/001; B26D 5/00; B23D 55/088; B26D 2001/008; B26D 1/03; B26D 1/547; B26D 1/553; B23D 57/0061

(57) ABSTRACT

An apparatus for detecting the breakage of at least one cutting element disposed in a guide includes at least one sliding piece which is linearly displaceable relative to the guide and which can be connected to the cutting element for holding the cutting element. A force applying element is provided to produce a force on the sliding piece so that if the cutting element breaks, the sliding piece is displaced relative to the guide. A sensor detects such a displacement of the sliding piece relative to the guide. A system having the detection device is also provided.

The invention relates to an apparatus for detecting the breakage of at least one cutting element arranged in a guide, comprising at least one sensor.

During the industrial production of ready-baked baked goods in the food industry, there is a need that the baked products must be trimmed. The same applies to further processed baked goods which inter alia can be coated, joined or finished in some other way. For trimming, the baked product is moved relative to a cutting element, for example, a cutting wire or a cutting band by means of which the baked product is divided. Apparatuses are known in which this cutting wire or this cutting band is clamped at both ends in a guide and is tensioned by means of a tensioning device.

A requirement for such cutting systems is that the wastage of cut material should be minimized. A further requirement is that a breakage of the cutting wire or cutting band should be detected as immediately as possible in order to avoid damage to the baked product or delays in the production.

This and other objects are solved according to the invention by an apparatus according to claim 1.

According to the invention it is provided that at least one sliding piece which is linearly displaceable relative to the guide and which can be connected to the cutting element is provided for holding the cutting element. A force-applying element is provided which produces a force on the sliding piece so that if the cutting element breaks, the sliding piece is displaced relative to the guide by this force. The sensor is designed for detecting such a displacement of the sliding piece relative to the guide so that the sensor detects a breakage of the cutting element.

According to the invention, it can be provided that the cutting element is additionally subjected to a tensioning force which is stronger than the force of the force-applying element and counteracts this. This is particularly advantageous when using a cutting wire as cutting element. If the sliding piece is accordingly subjected to the tensioning force for tensioning the cutting element, the sliding piece overcomes the counteracting force of the force-applying element and goes into a tensioning position. A stop for the sliding piece can be provided in the guide for setting the end point. If the cutting element is broken, this tensioning force is omitted and the sliding piece is displaced by the force of the force-applying element into a new position which uniquely characterizes the breakage of the cutting element and can be evaluated digitally.

According to the invention, it can be provided that the force applying element is arranged on the guide or is part of the guide. According to the invention, it can also be provided that the force applying element is arranged on the sliding piece or is part of the sliding piece.

According to the invention, it can be provided that a signal-triggering element cooperating with the sensor is arranged on the sliding piece.

According to the invention, it can be provided that the sensor is preferably designed as a laser curtain, as a light curtain, induction sensor, capacitance sensor, pneumatic sensor, hydraulic sensor or magnetic sensor.

According to the invention, it can be provided that the sensor is designed as a laser curtain with a transmitter and a receiver and the signal-triggering element is designed as a projection, wherein the laser curtain is adapted to detect the position of the projection relative to the guide.

According to the invention, it can be provided that the force-applying element is designed as a spiral spring, in particular a spiral compression spring, plate spring, pneumatic element, hydraulic element or magnetic element. In particular, the force-applying element can be designed as a spiral compression spring which on the one hand acts on the guide and on the other hand acts on the sliding piece.

According to the invention, it can be provided that the sliding piece is arranged in a recess of the holder, wherein a stop is provided for defining an end point of the sliding piece.

According to the invention, it can be provided that the cutting element is designed as a cutting wire or cutting band. According to the invention, it can in particular be provided that this cutting element can be subjected to a tensioning force which is stronger than the force of the force-applying element.

According to the invention, it can be provided that a preferably tensile fixing device is provided on the sliding piece for fixing the cutting element.

The invention further comprises a system for dividing baked goods comprising at least one cutting element and at least one detection device according to the invention.

According to the invention, it can be provided that a detection device according to the invention is provided on one or on both ends of at least one cutting element. Thus, one end of the cutting element can be fixed on the guide and another end can be fastened to the sliding piece of a detection device according to the invention.

According to the invention, it can be provided that at least two cutting elements are arranged parallel to one another in the guide. According to the invention, it can be provided in particular that a plurality of detection devices according to the invention are arranged adjacent to one another in the guide serving as a frame.

According to the invention, it can be provided that the same sensor is provided for at least two detection devices. According to the invention, it can be provided in particular that a plurality of detection devices according to the invention are arranged adjacent to one another in the guide serving as a frame and are queried by a single sensor.

According to the invention, it can be provided that an arrangement for single or multiple angular deflection of the cutting element is provided, wherein preferably a deflection by an angle of 180° is provided.

Preferably the apparatus according to the invention is a part of a cutting station for cutting or trimming wafer blocks, in particular in a system for the industrial production of wafer products from wafer sheets with crispy brittle consistency which are baked under pressure in a baking tong oven with lockable baking tongs.

Further features according to the invention are obtained from the patent claims, the description of the embodiments according to the invention and the figures

In the following embodiments of the apparatus according to the invention are described in detail with reference to the figures.

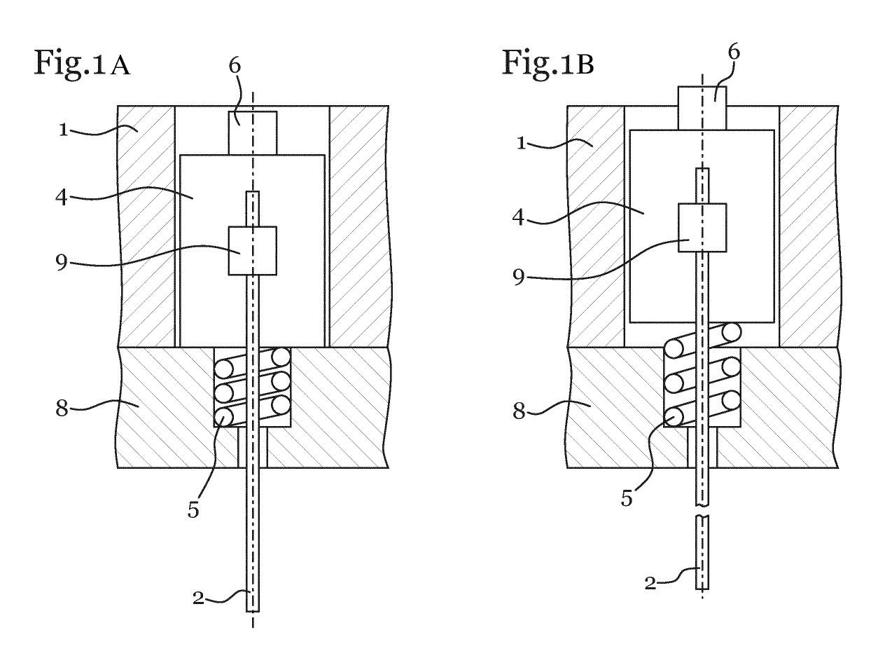

FIG. 1a shows an embodiment of an apparatus according to the invention with an intact cutting element 2. The cutting element 2 is fixed by means of a fixing apparatus 9 on a linearly displaceable sliding piece 4 and clamped in a guide 1. The sliding piece 4 is arranged in a recess of the guide 1 in such a manner that it is merely movable in the direction of the cutting element 2, i.e. only has one degree of freedom. When fastening the cutting element 2, a tensioning force is preferably applied to the sliding piece 4 so that the sliding piece 4 is pressed against a stop 8 in the recess of the guide 1.

A force-applying element 5 in the form of a spiral compression spring is arranged in the guide 1 which presses the sliding piece 4 away from the stop 8. However the tensioning force of the intact cutting element 2 is higher than the force of the force-applying element 5 so that when the cutting element 2 is intact, the sliding piece 4 is pressed against the stop 8. A signal-triggering element 6 in the form of a projection is arranged on the sliding piece 4 which however in the intact, i.e. tensioned state of the cutting element 2 does not project beyond the surface of the guide 1.

FIG. 1b shows the apparatus according to the invention from FIG. 1 after breakage of the cutting element 2. As a result of the breakage of the cutting element 2, the tensioning force on the sliding piece 4 is absent and the force of the force-applying element 5 displaces the sliding piece 4 upwards. The signal-triggering element 6 is pressed upwards with the sliding piece 4 and now projects beyond the surface of the guide 1.

FIGS. 1c and 1d show the apparatus according to the invention from FIG. 1a and FIG. 1b in a further view together with a sensor 3. The sensor 3 is designed as a light curtain, optionally as a laser curtain and comprises a transmitter 10 and a receiver 7. As a result of the displacement of the sliding piece 4 in the event of a breakage of the cutting element 2, the signal-triggering element enters into the light beam between transmitter 10 and receiver 7 so that the sensor 3 detects the breakage.

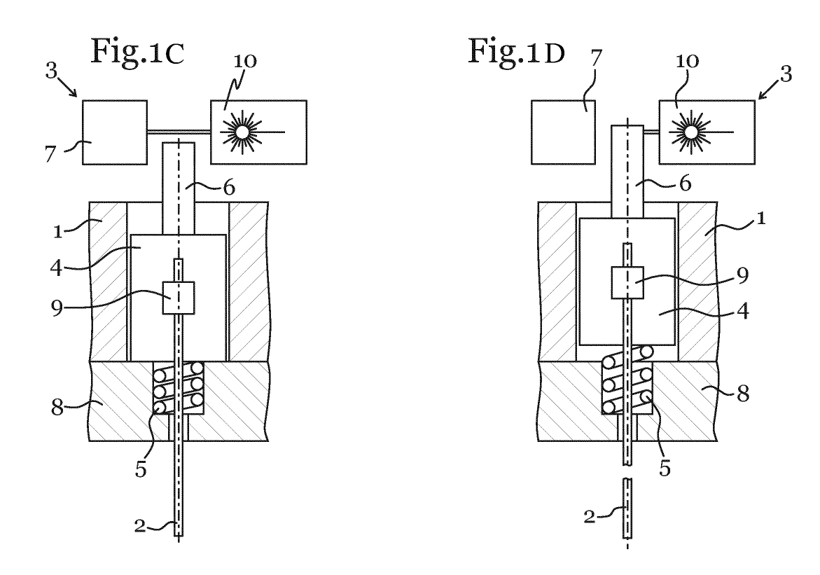

FIG. 2 shows a system according to the invention with a plurality of detection devices which are arranged next to one another in a frame which forms the guide 1 according to the invention. The adjacent detection devices (a), (b) and (c) are shown.

Case (a) shows the basic solution in which one end of the cutting element 2 is fixed on the guide 1 and the other end is fitted with the detection device according to the invention. In this case it is sufficient if the upper region of the guide 1 is fitted with a sensor in order to detect a displacement of the single sliding piece.

Case (b) shows a design in which both ends of the cutting element 2 are fitted with a detection device according to the invention. This allows a redundancy and higher process safety during detection since not one sensor but two sensors detect a breakage of the cutting element. In this case, sensors are arranged on the upper and lower region of the guide 1. The figure shows the case of breakage.

Case (c) shows a design in which the cutting element 2 is multiply deflected in order to achieve that a detection device according to the invention can be attached to both ends of the cutting element 2 and nevertheless only one sensor needs to be provided. In the case of breakage both adjacent detection devices react and a simple evaluation can be made with only one light beam of a single sensor.

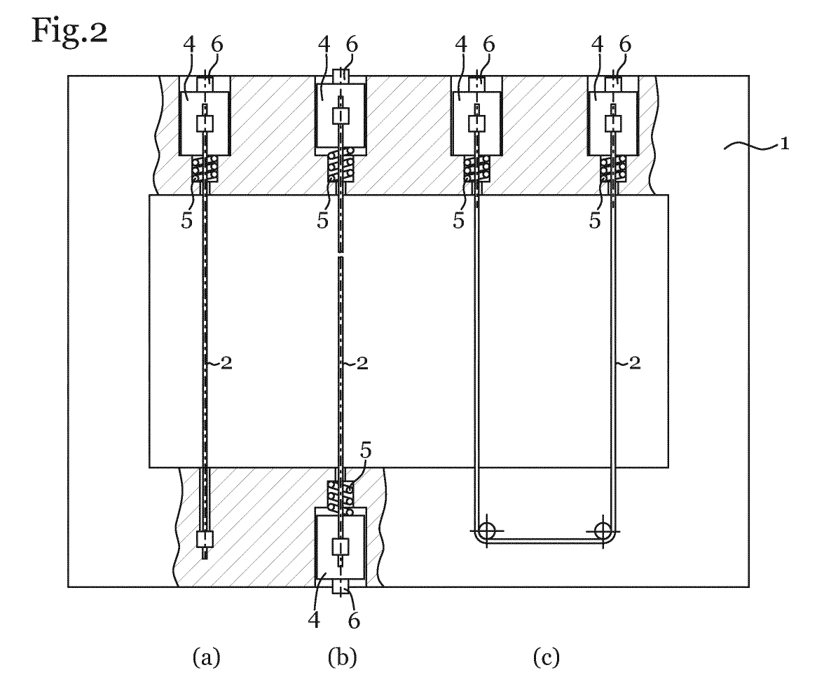

FIG. 3 shows a system according to the invention with a plurality of cutting elements 2 arranged adjacent to one another in a frame acting as a guide 1. In this exemplary embodiment a separate sensor 3 is provided for each sliding piece 4. This has the advantage that when a breakage is detected, it can be determined immediately which of the cutting elements 2 is broken.

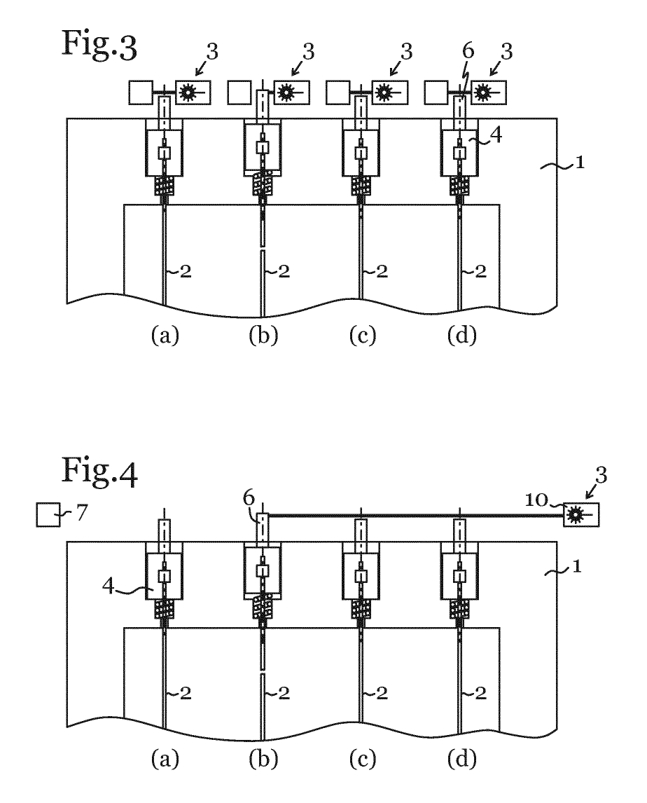

FIG. 4 shows a system according to the invention with a plurality of cutting elements 2 arranged in a frame acting as a guide 1. In this exemplary embodiment the same sensor 3 is provided for all the sliding pieces 4. This is made possible since the sliding pieces 4 and their projections serving as signal-triggering elements 6 are aligned precisely onto the position of the sensor 3 in the form of a light curtain with sensor 10 and receiver 7. If one of the signal-triggering elements 6 breaks the light beam, a wire break is detected. This has the advantages that only one light curtain must be provided.

The invention is not restricted to the exemplary embodiments shown but covers all devices and systems within the framework of the following patent claims.

### Reference List

1 Guide
2 Cutting element
3 Sensor
4 Sliding piece
5 Force-applying element
6 Signal-triggering element
7 Receiver
8 Stop
9 Fixing device
10 Transmitter

1-15. (canceled)

16. An apparatus for detecting a breakage of at least one cutting element disposed in a guide, the apparatus comprising:
a) at least one sliding piece being linearly displaceable relative to the guide, said at least one sliding piece configured to be connected to the cutting element for holding the cutting element;
b) a force applying element producing a force on said at least one sliding piece for displacing said at least one sliding piece relative to the guide if the cutting element breaks; and
c) at least one sensor for detecting said displacement of said at least one sliding piece relative to the guide.

17. The apparatus according to claim 16, wherein said force applying element is disposed on the guide or is part of the guide.

18. The apparatus according to claim 16, wherein said force applying element is disposed on said at least one sliding piece or is part of said at least one sliding piece.

19. The apparatus according to claim 16, which further comprises a signal-triggering element disposed on said at least one sliding piece and cooperating with said at least one sensor.

20. The apparatus according to claim 19, wherein said at least one sensor is a laser curtain, a light curtain, an induction sensor, a capacitance sensor, a pneumatic sensor, a hydraulic sensor or a magnetic sensor.

21. The apparatus according to claim 19, wherein:
said signal-triggering element is a projection;
said at least one sensor is a laser curtain with a transmitter and a receiver; and
said laser curtain is adapted to detect a position of said projection relative to the guide.

22. The apparatus according to claim 16, wherein said force-applying element is a spiral spring, a spiral compression spring, a plate spring, a pneumatic element, a hydraulic element or a magnetic element.

23. The apparatus according to claim 16, which further comprises a stop for defining an end point of said at least one sliding piece, said at least one sliding piece being disposed in a recess of the guide.

24. The apparatus according to claim 16, wherein the cutting element is a cutting wire or cutting band.

25. The apparatus according to claim 16, which further comprises a fixing device disposed on said at least one sliding piece for fixing the cutting element.

26. The apparatus according to claim 25, wherein said fixing device is a tensile fixing device.

27. The apparatus according to claim 16, which further comprises:
a stop defining an end point of said at least one sliding piece;
said force-applying element applying a force acting on said at least one sliding piece being smaller than a tensioning force applied to said at least one sliding piece by the tensioned cutting element when the cutting element is intact, causing said at least one sliding piece to be pressed onto said stop when the cutting element is intact.

28. A system for dividing baked goods, the system comprising:
at least one cutting element; and
at least one detection device according to claim 16.

29. The system according to claim 28, wherein said at least one cutting element has two ends, and said at least one detection device includes a respective cutting element disposed on one or on both of said ends of said at least one cutting element.

30. The system according to claim 28, wherein said at least one cutting element includes at least two cutting elements disposed parallel to one another in the guide.

31. The system according to claim 28, wherein said at least one detection device includes at least two detection devices, and said at least one sensor is one sensor provided for said at least two detection devices.

32. The system according to claim 28, which further comprises a configuration for single or multiple angular deflection of said cutting element.

33. The system according to claim 32, wherein said configuration deflects said cutting element by an angle of 180° .
